(19) United States
(12) Patent Application Publication
(10) Pub. No.: US 2026/0330439 A1
(43) Pub. Date: Oct. 22, 2026

(54) Modular Data Transaction System and Method with Secure Anonymization, Dynamic Pricing, and Automated Revenue Distribution

(71) Applicant: AvivID Innovative Media CO., LTD., Taipei City (TW)

(72) Inventors: Chih-Yao Lin, Taipei City (TW); Yu-Tsun Chang, Taipei City (TW); Chun-I Chen, Taipei City (TW)

(21) Appl. No.: 19/288,892

(22) Filed: Aug. 1, 2025

(30) Foreign Application Priority Data
Apr. 21, 2025 (TW) 114114984

(51) Int. Cl. G06Q 20/22; G06F 21/62; G06Q 20/08; G06Q 20/36

(52) U.S. Cl. CPC G06Q 20/22; G06F 21/6254; G06Q 20/0855; G06Q 20/36

(57) ABSTRACT

A modular data transaction system and corresponding method are disclosed. The system comprises: a data transaction module configured to integrate with an existing data management system of a data provider and to process raw data records by anonymizing personally identifiable information—via pseudonymization or hashing—and attaching predefined tags to generate a plurality of anonymized data packages; a data package purchase interface configured to display and provide access to the anonymized data packages for selection and purchase by buyers; and a transaction processing module configured to calculate the price of each data package based on predefined pricing parameters, to process payment transactions, and to automatically distribute proceeds to the data provider, resellers, and intermediaries based on a predefined revenue sharing scheme. The modular architecture enables seamless integration with heterogeneous data platforms and facilitates secure, efficient, and automated data exchange and revenue distribution.

### FIELD OF THE DISCLOSURE

The present invention relates generally to systems for data exchange and monetization, and more particularly to a modular and secure data transaction system that enables data providers to bundle, anonymize, and sell data packages, while facilitating automated pricing and revenue sharing among multiple parties.

### BACKGROUND OF THE INVENTION

With the rapid growth of digital data in recent years, there has been an increasing demand for efficient and secure methods of data exchange. Data transaction platforms have become an important means by which enterprises can monetize their data assets, allowing data providers to supply information for use in market research, targeted advertising, and other applications.

However, conventional data transaction systems often rely on centralized intermediaries to aggregate and resell data, or they require data providers to develop and maintain proprietary systems for selling their data. These approaches suffer from several limitations.

For example, traditional platforms often involve the transmission of raw data that may include personally identifiable information (PII), raising significant privacy concerns and potential violations of data protection regulations. Many existing solutions lack robust mechanisms for data anonymization or pseudonymization, thereby increasing the risk of unauthorized disclosure of sensitive information.

Additionally, data providers typically manage their data using a variety of heterogeneous systems, such as membership databases, customer relationship management (CRM) systems, or customer data platforms (CDPs). The lack of standardized interfaces or modules to facilitate secure data exchange among these systems often results in data silos. This fragmentation hinders efficient data transactions and reduces the potential for bundling data assets across multiple providers.

Moreover, many current solutions fail to provide integrated mechanisms for dynamically pricing data packages or automating the financial aspects of data transactions. Without a streamlined process for calculating fees based on data characteristics (e.g., number of anonymization tags) and distributing proceeds among data providers, resellers, and intermediaries, operational inefficiencies and administrative burdens are likely to increase.

Furthermore, traditional data transaction models frequently restrict providers to selling only their own data, failing to promote a broad market environment where data from multiple sources can be bundled and offered to buyers. Such limitations suppress cross-selling opportunities and diminish the overall economic value of the data transaction ecosystem.

Accordingly, there exists a pressing need in the market for an integrated data transaction system that addresses the foregoing limitations.

### SUMMARY OF THE INVENTION

The present invention provides a modular data transaction system and a secure data transaction method designed to enable secure, efficient, and automated data exchange among multiple parties. Specifically, the invention overcomes the limitations of conventional data transaction platforms by integrating robust privacy-preserving data processing, dynamic pricing mechanisms, and automated revenue sharing within a unified and scalable framework.

In one embodiment, the invention provides a data transaction system comprising a data transaction module, a data package purchase interface, and a transaction processing module. The data transaction module is configured to integrate with existing data management systems of a data provider, to receive raw data records, and to process the records by anonymizing personally identifiable information—such as through pseudonymization or hashing—and attaching predefined tags to form anonymized data packages. This ensures the protection of sensitive information while preserving the ability to maintain meaningful linkages through metadata.

The data package purchase interface is operably connected to the data transaction module and is configured to display one or more anonymized data packages, each representing a bundle of processed data records. Buyers can access and select these data packages through the interface, which may be embedded in the data provider's own system or website, thereby maintaining the provider's branding and control over the data assets.

The transaction processing module is communicatively connected to both the data transaction module and the data package purchase interface. It is configured to calculate the price of each data package based on predefined pricing parameters—for example, by multiplying the number of tags associated with each data record by a unit tag price. The transaction processing module is further configured to handle payment transactions, such as through a prepaid wallet mechanism, and to automatically distribute revenue among participating entities according to a predefined revenue sharing scheme.

In another embodiment, the invention provides a secure data transaction method comprising the steps of:
(1) integrating a data transaction module into an existing data management system of a data provider;
(2) receiving raw data records from the data provider's system;
(3) anonymizing the raw data records by removing or pseudonymizing personally identifiable information and attaching one or more predefined tags to generate anonymized data packages;
(4) providing access to one or more anonymized data packages through a data package purchase interface;
(5) enabling a buyer to select and purchase at least one of the anonymized data packages; and
(6) calculating the purchase price based on predefined pricing parameters, including the unit tag price and the number of tags per data package, and automatically distributing revenue among participating entities according to a predefined revenue sharing scheme.

The modular design of the data transaction system enables seamless integration with a variety of data management platforms, such as membership databases, customer relationship management (CRM) systems, or customer data platforms (CDPs). This allows data providers to participate in a broader data transaction ecosystem while retaining control over their data assets. By employing advanced anonymization techniques and standardized tagging, the system not only ensures compliance with privacy regulations but also facilitates fair and efficient distribution of revenue through dynamic pricing and automation.

In summary, the present invention offers a comprehensive and scalable solution for secure data transactions, bridging technical functionality with innovative business models and addressing longstanding challenges in data monetization.

To make the above features and advantages of the present invention more apparent and understandable, a preferred embodiment is exemplified below, in conjunction with the accompanying drawings, for detailed description.

### BRIEF DESCRIPTION OF THE DRAWINGS

FIG. 1 is a schematic diagram illustrating an example architecture of a data transaction system according to one embodiment of the present invention.

FIG. 2 is a diagram illustrating how different entities are interconnected through the data transaction system of the present invention.

FIG. 3 is a flowchart illustrating the operational process of the data transaction system according to the present invention.

### DESCRIPTION OF THE PREFERRED EMBODIMENTS

Reference will now be made to various embodiments of the present invention, which provides a modular data transaction system and a secure data exchange method that can be integrated into the infrastructure of existing data management systems. The following description is provided for illustrative purposes only and is not intended to limit the scope of the invention. In some embodiments, the components or modules of the data transaction system may be implemented in hardware, software, or any combination thereof, and their functions may be executed by one or more processors executing computer-executable instructions stored in non-transitory computer-readable media.

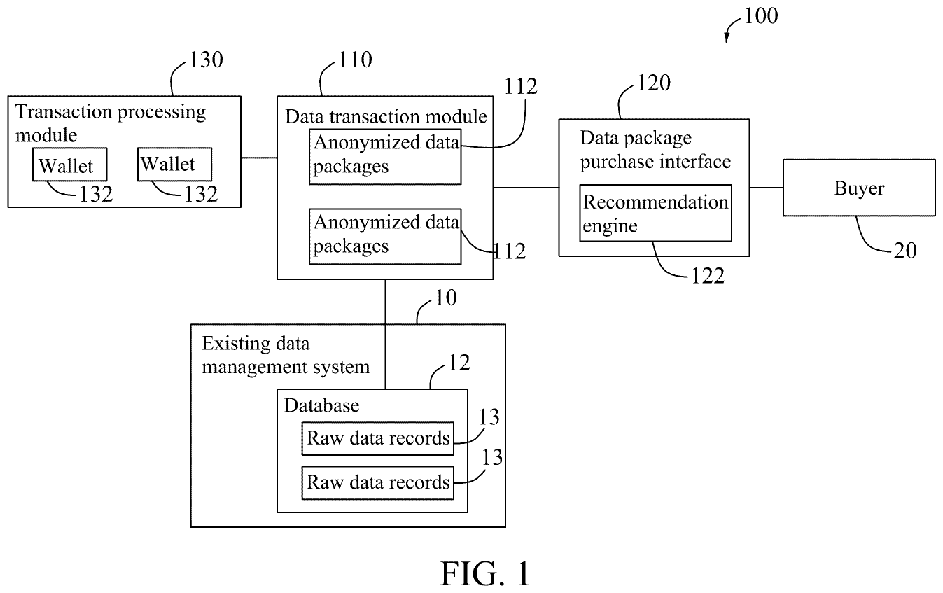

Referring to FIG. 1, which illustrates a schematic architecture of a data transaction system 100 in accordance with one embodiment of the present invention, the system comprises three primary functional components: a data transaction module 110, a data package purchase interface 120, and a transaction processing module 130. The data transaction module 110 is integrated into an existing data management system 10 of a data provider. The data package purchase interface 120 is configured to present anonymized and tagged data packages to potential buyers 20. The transaction processing module 130 is responsible for dynamically calculating pricing based on a predefined revenue distribution scheme, processing payment transactions, and distributing proceeds accordingly. These three core components cooperate to securely process, bundle, and exchange data in compliance with regulatory requirements while enabling efficient commercial transactions. Each of these components is described in greater detail below.

The data transaction module 110 is configured to communicate with a database 12 of the data provider and is responsible for receiving raw data records 13. In this embodiment, the data transaction module 110 performs operations including data reception, anonymization, and tagging. Data reception refers to the process whereby the data transaction module 110 retrieves raw data records 13 from the database 12 within the existing data management system 10 of the data provider. These raw data records 13 may include personally identifiable information (PII) and other sensitive data.

The anonymization and tagging process involves removing or pseudonymizing directly identifiable personal data to protect privacy. Techniques such as hashing, encryption, or pseudonymization may be employed for this purpose. After anonymization, one or more predefined tags are appended to each data record. These tags represent specific attributes—such as user interests, demographic information, or behavioral patterns—and enable subsequent categorization and bundling of the data. For example, in a membership database, a record containing a user's contact information may be processed so that directly identifying information is replaced with a hashed value. Additional metadata (e.g., purchase history, age group) may also be appended. The processed, anonymized, and tagged data records are then aggregated into anonymized data packages 112, which serve as the basis for subsequent transactions.

The data package purchase interface 120 is communicatively linked to the data transaction module 110 and serves as the user access interface for the data transaction system. In this embodiment, the data package purchase interface 120 presents multiple (or at least one) anonymized data packages 112 to potential buyers 20. Each anonymized data package 112 represents a bundle of anonymized data records defined by their associated tags. The interface allows the buyer 20 to view detailed descriptions of each anonymized data package 112 through a website, an embedded interface, or other user-accessible application.

In some embodiments, the data package purchase interface 120 may include filtering or search functionality to enable buyers 20 to locate data packages that meet specific criteria, such as targeting a particular demographic segment.

Additionally, the data package purchase interface 120 includes a recommendation engine 122, which suggests complementary or otherwise relevant anonymized data packages 112 based on the buyer's selection history or the attributes of the currently viewed data packages. This facilitates cross-selling and enables buyers 20 to assemble and purchase multiple different but related anonymized data packages according to their needs.

The transaction processing module 130 is configured to manage pricing, payment, and revenue distribution associated with the data transactions. In this embodiment, the transaction processing module 130 calculates the price of each anonymized data package 112 based on predefined pricing parameters. For example, the price may be determined by a formula that multiplies the number of tags applied to a given data package by a unit price per tag. One exemplary pricing formula is as follows:

Price=(Number of anonymized data packages)×(Number of tags per Data Package)×(unit Price Per Tag)

The transaction processing module 130 also facilitates payment transactions using secure mechanisms. In one embodiment, a prepaid wallet mechanism is used. The buyer may fund a wallet 132 using a credit card or other acceptable payment methods. Upon confirmation of the purchase of anonymized data packages 112, the transaction processing module 130 automatically deducts the corresponding amount from the wallet 132. If the balance in the wallet 132 is insufficient, the transaction processing module 130 notifies the buyer and suspends further transactions until sufficient funds are added.

Moreover, the transaction processing module 130 is further configured to automatically distribute the proceeds from each data transaction among the participating entities according to a predefined revenue sharing scheme. For instance:
A primary percentage of the revenue (e.g., 85%) may be allocated to the data provider who sells their own data;
A smaller percentage (e.g., 2%) may be allocated as a commission to a provider who resells third-party data;
A remaining portion (e.g., 15%) may be allocated to a third-party intermediary (e.g., the developer or operator of the data transaction system 100) that facilitates the transaction.

This automated distribution ensures that all parties are fairly compensated in accordance with their roles within the data transaction ecosystem.

The following hypothetical example illustrates the capabilities of the data transaction system 100 described above. Referring again to FIG. 1, assume a retail company maintains a membership database (corresponding to database 12 in FIG. 1) that contains customer purchase history and demographic information (corresponding to raw data records 13 in FIG. 1). The retail company wishes to monetize this data while ensuring compliance with data privacy regulations. To achieve this, the company can implement the data transaction system 100 by integrating the data transaction module 110 into its existing membership database.

The data transaction module 110 processes the raw customer data by removing directly identifiable personal information and appending tags that reflect purchasing behavior and demographic attributes. The processed and anonymized data records are then organized into anonymized data packages 112, which are made available for viewing via the data package purchase interface 120 embedded on the company's website.

A potential buyer 20, such as an advertising agency seeking to target specific customer segments, accesses the data package purchase interface 120 to review the available anonymized data packages 112 and selects those that meet their targeting criteria. The transaction processing module 130 dynamically calculates the total price of the selected anonymized data packages 112 based on the number of packages, the number of tags associated with each package, and the unit price per tag. Upon confirmation of the purchase, the transaction processing module 130 automatically deducts the corresponding amount from the buyer's prepaid wallet 132, and then distributes the proceeds to the participating entities—such as the retail company, any reselling partners, and third-party intermediaries—in accordance with the predefined revenue sharing scheme.

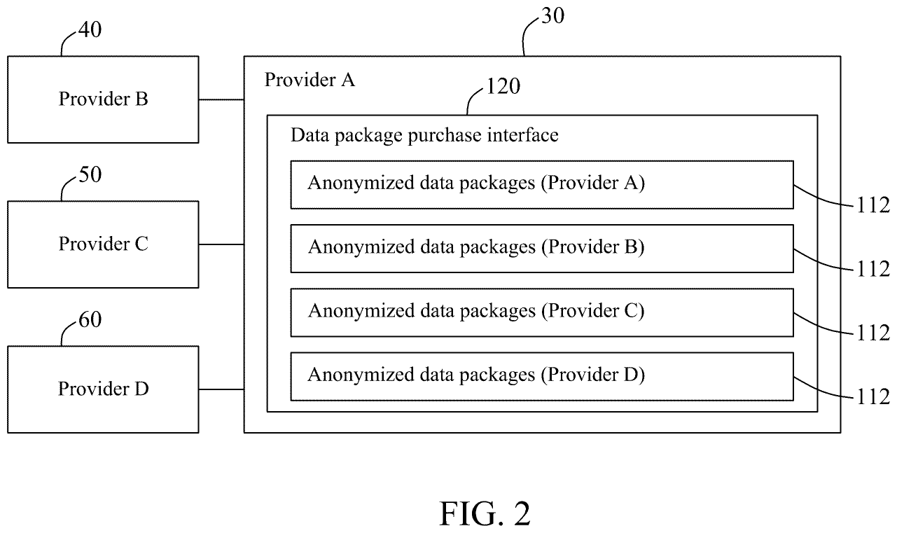

Referring now to FIG. 2, which illustrates how different providers are interconnected through the data transaction system of the present invention, the following explanation describes how the data package purchase interface 120 can display complementary anonymized data packages 112 from other data providers, and how the system implements a commission mechanism when such packages are purchased.

Specifically, the data package purchase interface 120 is configured not only to display anonymized data packages 112 generated by the provider integrated with that interface (e.g., Provider A 30), but also to display anonymized data packages 112 from other data providers (e.g., Providers B 40, C 50, and D 60). In other words, any entity that installs the data transaction system 100 can make its anonymized data packages 112 visible through other providers'purchase interfaces.

For example, when a buyer 20 accesses the data package purchase interface 120 of Provider A 30, the interface presents not only the anonymized data packages 112 offered by Provider A 30 but also displays a selection of anonymized data packages 112 offered by other providers. In one embodiment, if the buyer 20 selects and purchases an anonymized data package 112 from Provider A 30, the interface may simultaneously recommend complementary or related anonymized data packages 112 from Provider B 40. These complementary data packages may be associated by topic, customer demographic attributes, or other predefined criteria, thereby making them relevant as supplemental or enhanced offerings.

In embodiments where complementary anonymized data packages 112 are displayed, the transaction processing module 130 is further configured to detect when a buyer, after purchasing an anonymized data package 112 from Provider A 30, subsequently purchases a complementary anonymized data package 112 from Provider B 40 via the data package purchase interface 120 of Provider A 30. In such cases, the transaction processing module 130 not only allocates a predefined portion of the purchase revenue to Provider B 40, but also automatically allocates another predefined portion as a commission to Provider A 30. This mechanism incentivizes data providers to form collaborative partnerships and fosters a more integrated data transaction ecosystem in which complementary data products can be jointly marketed and monetized.

As previously mentioned, the data package purchase interface 120 may include the recommendation engine 122. In this context, the recommendation engine 122 suggests additional anonymized data packages not only based on the buyer's past selection history or the attributes of purchased data packages but also includes complementary anonymized data packages from other data providers. These recommendations are displayed alongside the buyer's selected or purchased data packages 112 within the interface. By highlighting such relevant products, the data transaction system 100 increases the likelihood that buyers will purchase multiple anonymized data packages 112.

In summary, integrating and displaying complementary anonymized data packages from other data providers, along with implementing the corresponding commission mechanism, provides several key advantages:
1. Enhanced Buyer Experience: Buyers are presented with a more comprehensive view of available data, including complementary anonymized data packages 112 that may enhance the value of their initial purchase.
2. Increased Revenue Opportunities: Data providers can benefit not only from direct sales of their own anonymized data packages 112, but also from additional commission revenue when their offerings lead to subsequent purchases of complementary products.
3. Promotion of Collaboration: The cross-selling mechanism encourages cooperation among data providers, supporting the development of a more interconnected and mutually beneficial data transaction ecosystem.

As an illustrative example, consider a large retail chain (corresponding to Provider A 30 in FIG. 2) that integrates the data transaction module 110 into its membership database. Anonymized data packages 112 derived from its customer data are made available through the data package purchase interface 120. When an advertising agency (buyer 20) purchases one of these anonymized data packages 112, the interface simultaneously displays related anonymized data packages from a manufacturer (corresponding to Provider B 40 in FIG. 2), whose demographic or behavioral data complements that of the retailer. If the advertising agency subsequently purchases the complementary anonymized data package 112 from Provider B 40, the transaction processing module 130 allocates a commission to the retailer based on the revenue sharing scheme. This arrangement not only compensates the manufacturer for the sale of its data, but also rewards the retailer for enabling a cross-selling opportunity—thereby enhancing the overall commercial efficiency of the system.

Another significant advantage of the present invention lies in its modular architecture. The data transaction module 110 is designed as a software plug-in that can be tightly integrated into various data management systems without requiring substantial modifications to the existing infrastructure of the data provider. This modular design offers the following benefits:
1. Interoperability: The data transaction system 100 can interface with various types of databases and platforms, enabling data providers from different industries to participate in the data transaction ecosystem.
2. Scalability: As the volume of data or the number of participating providers increases, the modular design allows the system to scale easily. New modules or enhanced features—such as advanced anonymization technologies or additional payment options—can be integrated without disrupting existing functionality.
3. Flexibility: The data transaction system 100 supports various business models, ranging from direct data sales to complex multi-party transactions. Its dynamic pricing and revenue sharing mechanisms can be tailored to meet the specific needs of different market segments.

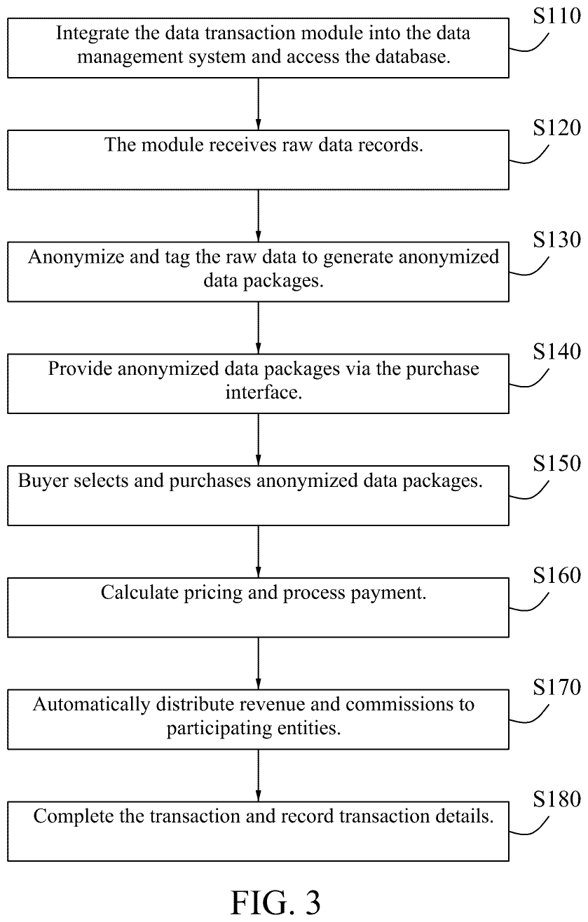

Referring now to FIG. 3, which illustrates an operational flow diagram of the data transaction system according to the present invention, the process includes the following steps.

First, in step S110, the data transaction module 110 is integrated into the data provider's existing data management system 10. This integration enables the data transaction module 110 to access the database where raw data records are stored.

Upon completion of integration, step S120 is executed, wherein the data transaction module 110 receives raw data records 13 from the data provider's database 12. These raw data records 13 typically include personally identifiable information (PII) and other sensitive data elements.

Next, in step S130, the raw data records 13 undergo an anonymization process. This involves removing or pseudonymizing PII using techniques such as hashing, encryption, or pseudonymization, and attaching one or more predefined tags to each record. These tags allow for maintaining linkage in an anonymized format and facilitate subsequent data classification and bundling. As a result of this step, anonymized data packages 112 are generated.

In step S140, the anonymized data packages 112 are made accessible via the data package purchase interface 120. This interface is designed not only to display anonymized data packages 112 from the integrated data provider but also to present complementary or related anonymized data packages from other data providers. This allows buyers to explore additional offerings that can supplement or enhance their initially selected data packages.

Then, in step S150, the buyer accesses the data package purchase interface 120 to review the available anonymized data packages and selects at least one for purchase. In some embodiments, the interface also utilizes an integrated recommendation engine to suggest complementary data packages based on the buyer's selection history or the attributes of the chosen data packages.

Once the buyer has made a selection, step S160 is executed. In this step, the transaction processing module 130 calculates the purchase price of the selected anonymized data packages based on predefined parameters, such as the number of anonymized data packages, the number of tags associated with each package, and the unit price per tag. The module then processes the payment transaction, for example, by deducting the calculated amount from a prepaid wallet associated with the buyer. If the wallet balance is insufficient, the transaction processing module 130 notifies the buyer and suspends further transactions until the required funds are replenished.

Upon successful completion of the purchase, step S170 is performed. In this step, the transaction processing module 130 automatically distributes the proceeds of the transaction among participating entities in accordance with a predefined revenue sharing scheme. For instance, when a buyer initially purchases an anonymized data package 112 from Provider A 30, and subsequently purchases a related anonymized data package 112 from Provider B 40, the transaction processing module 130 distributes a portion of the payment to Provider B 40 and automatically allocates a commission to Provider A 30. This mechanism promotes cross-selling and encourages collaboration among data providers.

As illustrated in step S180, the entire process concludes with the buyer being granted access to the purchased anonymized data packages. Additionally, the data transaction system 100 records complete transaction details for reporting and audit purposes.

The following description provides additional details regarding the specific implementation of the key modules of the data transaction system. These examples are provided to illustrate how the invention can be concretely realized and are not intended to limit the scope of the invention in any way.

In one embodiment, the data transaction module 110 is implemented as a software plug-in designed to integrate tightly with existing data management systems, such as membership databases, customer relationship management (CRM) systems, or customer data platforms (CDPs). In one implementation, the data transaction module 110 is deployed in a Linux-based server environment using a containerized microservices architecture, such as Docker.

The data transaction module 110 communicates with the data provider's existing database 12 via a secure RESTful API, utilizing standard web service protocols such as HTTP/HTTPS to ensure secure and reliable data exchange.

In one embodiment, after receiving raw data records 13, the data transaction module 110 applies one-way hashing (e.g., SHA-256) to personally identifiable information using cryptographic libraries such as OpenSSL or Bouncy Castle. Depending on the implementation, the module may also perform pseudonymization of the raw data records 13 using the same libraries. Once the direct identifiers have been transformed, the module attaches one or more predefined tags to each record, which are stored as metadata. These tags are implemented as structured data elements (e.g., JSON objects) and are used to represent user attributes such as demographic information, behavioral patterns, or customer interests.

The processed records are aggregated into anonymized data packages 112. The packaging process is governed by configurable rules stored in a separate configuration file or database table. These rules define the grouping criteria, such as tag similarity or segmentation based on temporal data. The data transaction module 110 also logs all processing events into a secure audit log for subsequent inspection and compliance verification.

In one embodiment, the data package purchase interface 120 is implemented as a web-based application that provides buyers with access to anonymized data packages. For example, the interface may be developed using modern web technologies such as HTML5, CSS3, and JavaScript, and may utilize frameworks like React, Angular, or Vue.js to build a responsive and user-friendly interface that operates within standard web browsers. The data package purchase interface 120 communicates with backend services through secure AJAX or RESTful API calls.

In one implementation, the data package purchase interface 120 not only displays anonymized data packages 112 from the integrated data provider but also presents complementary anonymized data packages 112 from other data providers. An integrated recommendation engine 122, implemented as a microservice, analyzes buyer behavior based on selection history and data package attributes using rule-based logic or machine learning algorithms. The engine suggests additional data packages that may enhance the buyer's data acquisition strategy. These recommendations are dynamically updated in real time and are displayed alongside the primary data packages.

In another embodiment, the data package purchase interface 120 integrates an authentication module, such as one utilizing OAuth 2.0 or JSON Web Tokens (JWTs), to ensure that only authorized buyers can access anonymized data packages 112. All communication between the client and server is secured using SSL/TLS encryption protocols.

In one embodiment, the transaction processing module 130 is implemented as a backend microservice responsible for pricing, payment processing, and revenue distribution. The module includes a pricing engine that retrieves configurable pricing parameters—such as the unit price per tag and the number of tags per data package—from a secure configuration database, and calculates the price using predefined formulas. The pricing engine supports dynamic updates, allowing real-time recalculation as underlying data (e.g., tag counts) change.

In one embodiment, the transaction processing module 130 integrates with external payment gateways or a proprietary prepaid wallet system for payment processing. The module may be implemented using server-side languages such as Java, Python, or Node.js, and communicates with payment service providers via secure APIs. Upon purchase confirmation, the payment logic immediately deducts the required amount from the buyer's wallet account. If the balance is insufficient, the system automatically notifies the buyer and pauses further transactions until the necessary funds are replenished.

In one embodiment, the transaction processing module 130 includes a revenue distribution submodule configured to apply a predefined revenue-sharing algorithm to automatically calculate and allocate proceeds among participating entities. These entities may include a data provider who sells its own data, a reseller who offers complementary data packages from other providers, and a third-party intermediary that facilitates the transaction.

For example, if a buyer first purchases an anonymized data package 112 from Provider A 30 and subsequently selects a complementary anonymized data package 112 from Provider B 40, the transaction processing module 130 allocates the primary revenue to Provider B 40 and automatically assigns a predefined commission to Provider A 30. All transaction data is stored in a relational database, such as MySQL or PostgreSQL, with strict access controls and data-at-rest encryption.

Furthermore, the transaction processing module 130 maintains a detailed log of all financial transactions and revenue distribution events. These logs are designed to comply with relevant financial and data protection regulations and may be used for auditing and reporting purposes.

The specific implementation examples described above demonstrate that the data transaction module, data package purchase interface, and transaction processing module are not abstract concepts but can be practically realized through concrete hardware and software means. The components are designed to interoperate, delivering a secure, scalable, and fully integrated data transaction system that meets both technical and regulatory requirements. By leveraging modern development frameworks, secure communication protocols, and robust cryptographic techniques, the system ensures integrity, privacy, and commercial viability throughout the data transaction process.

It should be understood that the above-described embodiments may be subject to various modifications without departing from the scope of the present invention. For instance, although the system has been described using a pricing model based on the number of tags and the unit price per tag, other pricing strategies may also be employed, such as tiered pricing or subscription-based models.

Likewise, the anonymization techniques used may vary. Additional privacy-enhancing methods, such as differential privacy, may be implemented to further protect data. Differential privacy is a mathematical framework that introduces random noise into the data to ensure that no individual's personal information can be inferred during data sharing or analysis.

In conclusion, the present invention provides a comprehensive solution for secure, efficient, and automated data transactions by integrating privacy-preserving data processing, dynamic pricing, and automated revenue sharing into a modular and scalable system. By enabling the secure exchange of anonymized data between diverse data providers and buyers, the invention overcomes the limitations of traditional centralized data marketplaces and creates new opportunities for data monetization across industries.

Although the invention has been described with reference to specific embodiments, such embodiments are illustrative only and not limiting. It will be understood by those skilled in the art that various modifications, additions, and substitutions are possible without departing from the spirit and scope of the invention as defined by the appended claims. Accordingly, the legal scope of the invention is defined solely by the claims and their equivalents, and not by the foregoing description.

1. A data transaction system, comprising:
a data transaction module configured to integrate with at least one data management system of a data provider, the data management system comprising at least one database, wherein the data transaction module is configured to:
receive raw data records from the database of the data provider; and
generate a plurality of anonymized data packages by anonymizing personally identifiable information in the raw data records and attaching one or more predefined tags to each data record;
a data package purchase interface operatively connected to the data transaction module, the data package purchase interface configured to display the anonymized data packages, each anonymized data package corresponding to a bundle of data records for selection and purchase by at least one buyer; and
a transaction processing module communicatively connected to the data transaction module and the data package purchase interface, the transaction processing module configured to:
calculate a price for each anonymized data package based on a predefined pricing parameter; and
process payment transactions and automatically distribute proceeds to participating entities based on a predefined revenue sharing scheme.

2. The data transaction system of claim 1, wherein the data transaction module is configured to integrate with at least one of a membership database, a customer relationship management (CRM) system, or a customer data platform (CDP) of the data provider.

3. The data transaction system of claim 1, wherein the anonymizing step performed by the data transaction module comprises:
converting personally identifiable information using hashing, encryption, or pseudonymization to prevent re-identification of individual identities; and
retaining linkage capability through attachment of tags.

4. The data transaction system of claim 1, wherein the transaction processing module comprises a prepaid wallet mechanism configured to automatically deduct a fee upon final confirmation of data package purchase.

5. The data transaction system of claim 1, wherein the participating entities comprise:
a data provider who sells its own data;
a reseller who provides data of another data provider; and
a third-party intermediary who facilitates the data transaction.

6. The data transaction system of claim 1, further comprising a recommendation engine operatively linked to the data package purchase interface, the recommendation engine configured to suggest other anonymized data packages based on the buyer's selection history or the attributes of the purchased anonymized data packages.

7. The data transaction system of claim 1, wherein the data package purchase interface is further configured to display anonymized data packages from another data provider different from the data provider, the anonymized data packages from the other data provider being complementary or related to those provided by the data provider.

8. The data transaction system of claim 7, wherein the transaction processing module is further configured to allocate a commission to the data provider when the buyer subsequently purchases a complementary anonymized data package from the other data provider, in addition to distributing revenue to the other data provider.

9. A data transaction method, comprising:
integrating a data transaction module into a data management system of a data provider, the data management system comprising at least one database;
receiving raw data records from the database of the data provider;
anonymizing the raw data records by removing or pseudonymizing personally identifiable information and attaching one or more predefined tags to generate anonymized data packages;
providing access to the anonymized data packages through a data package purchase interface;
enabling a buyer to select and purchase at least one of the anonymized data packages via the data package purchase interface;
processing a payment transaction for the buyer's purchase; and
automatically distributing proceeds to participating entities based on a predefined pricing parameter and a predefined revenue sharing scheme.

10. The data transaction method of claim 9, wherein the revenue sharing scheme comprises:
allocating a first percentage of the proceeds to a data provider who sells its own data;
allocating a second percentage of the proceeds to a data provider who resells data of another data provider; and
allocating a third percentage of the proceeds to a third-party intermediary who facilitates the data transaction;
wherein the first percentage is greater than the second and third percentages.
